(19) United States
(12) Patent Application Publication
(10) Pub. No.: US 2025/0370547 A1
(43) Pub. Date: Dec. 4, 2025

(54) METHOD FOR INTERACTING WITH A VIRTUAL OBJECT, PROGRAM USING SAME, AND IMMERSIVE REALITY DEVICE

(71) Applicant: ORANGE, Issy-les-Moulineaux (FR)

(72) Inventor: Guillaume BATAILLE, CHATILLON CEDEX (FR)

(21) Appl. No.: 19/220,726

(22) Filed: May 28, 2025

(30) Foreign Application Priority Data
May 29, 2024 (FR) 2405520

(51) Int. Cl. G06F 3/01; G06V 40/20

(52) U.S. Cl. CPC G06F 3/017; G06V 40/28

(57) ABSTRACT

A method for interacting with a virtual object in an immersive reality, a program using same, and an immersive reality device in which a user is able to interact with a virtual object. The method includes, when a virtual hand associated with a real hand of a user of the immersive reality device is in the proximity of a virtual object, detecting a continuous gesture of the real hand, the detection of the continuous gesture triggering gripping of the virtual object by the virtual hand. A simple and continuous gesture is thus associated with triggering the gripping of the virtual object, without placing the real hand in a position incompatible with this gripping in terms of perception by the user.

### CROSS-REFERENCE TO RELATED APPLICATIONS

This Application claims priority to FR2405520, filed May 29, 2024, the content of which is incorporated herein by reference in its entirety.

### TECHNICAL FIELD

The present disclosure relates to a method for interacting with a virtual object in an immersive reality, to a program using same, and to an immersive reality device in which a user is able to interact with a virtual object.

### PRIOR ART

Nowadays, there are multiple immersive reality technologies, in particular:
virtual reality, which immerses the user in a totally created environment, be this imaginary or real, but which does not correspond to their present reality;
augmented reality, which is an enriched reality, that is to say with added information in relation to the reality of the user;
mixed reality, which combines virtual reality and augmented reality;
etc.

In all of these immersive realities, a user, who is a real person, is able to interact with virtual objects in these immersive realities. To interact with a virtual object, the user may either use interaction joysticks of the immersive reality system or interact with their real bare hand. In this second case, the immersive reality system is equipped with at least one camera able to capture the real hand of the user, allowing the immersive reality system to detect an interaction of the captured real bare hand with the virtual object.

However, current techniques allowing the real bare hand to interact with a virtual object are much less efficient than a physical manipulation of a real grippable object. Indeed, the user encounters problems and/or inconsistencies in terms of perception when attempting to manipulate a virtual object reproduced in immersive reality, for example by an immersive reality headset, a semi-immersive table, an immersive room, a holographic device, etc.

In particular, users have difficulties in interacting with a virtual object due to the absence of tangible contact with the virtual object. This leads to errors, or even absences of interaction in the immersive reality, and therefore to a degraded immersive experience that may lead to these immersive techniques not being adopted by users.

Moreover, immersive reality devices do not detect interactions with virtual objects of users seeking to comply with the geometry of the virtual object when interacting therewith, because these immersive reality devices currently use interaction techniques that validate the virtual picking up of the virtual object if the real hand closes (the fingers of the real hand of the user touch one another) by surrounding the virtual object (possibly without touching the virtual object), or even passing through the virtual object. It is thus rare that the position of the real hand needed to validate the gripping of the virtual object corresponds to picking up of the virtual object. Indeed, depending on the diameter of the virtual object and the diameter of the closed real hand, the user will not tend to command picking up of the virtual object either by surrounding the virtual object with the real hand without touching it (if the diameter of the virtual object is smaller than that of the closed real hand) or by passing through the virtual object with the real hand (if the diameter of the virtual object is greater than that of the closed real hand). Therefore, in this case too, this leads to errors or even absences of interaction in the immersive reality, and therefore to a degraded immersive experience that may lead to these immersive techniques not being adopted by users.

In addition, similar interaction problems arise when the user attempts to command the release of the virtual object. Indeed, the natural position of the real hand releasing the virtual object for the user is not necessarily associated with a release command in the immersive reality system, leading to an error in terms of the interaction with this virtual object, in particular the virtual object remaining stuck to the user's hand and moved unintentionally by the user during a movement of their real hand. In this case too, interaction errors in the immersive reality degrade the user's immersive experience.

### SUMMARY

One aspect of the present disclosure aims to rectify drawbacks of the prior art.

One aspect of the disclosure relates to a method for interacting with a virtual object reproduced by an immersive reality device, comprising:
when a virtual hand associated with a real hand of a user of the immersive reality device is in the proximity of a virtual object, detecting a continuous gesture of the real hand, the detection of the continuous gesture triggering gripping of the virtual object by the virtual hand.

A simple and continuous gesture is thus associated with triggering the gripping of the virtual object, without placing the real hand in a position incompatible with this gripping in terms of perception by the user.

Advantageously, the interaction method comprises:
taking the virtual object with the virtual hand as soon as a continuous gesture of the real hand is detected.

Advantageously, the interaction method comprises:
when the virtual hand is holding a virtual object, detecting the interruption of the continuous gesture of the real hand, the detection of interruption of the continuous gesture triggering the end of the gripping of the virtual object by the virtual hand.

The end of this simple and continuous gesture is thus associated with the triggering of the release of the virtual object as soon as the real hand is in a position compatible with this release of the virtual object in terms of perception by the user.

Advantageously, the interaction method comprises:
letting go of the virtual object held by the virtual hand as soon as interruption of the continuous gesture of the real hand is detected.

Advantageously, the virtual object is gripped by the virtual hand depending on the orientation of the palm of the virtual hand with respect to the virtual object when the continuous gesture is detected.

The virtual picking up of the virtual object is thus natural in terms of the position of the real hand for the user.

Advantageously, the interaction method comprises:
when the virtual hand is holding a virtual object, detecting a gesture of the real hand complementary to the detected continuous gesture, the detection of the complementary gesture triggering a rotation of the virtual object in the virtual hand.

Advantageously, the continuous gesture that is detected is contact of the thumb and the index finger of the real hand.

The continuous gesture is thus simple and is not subject to a distinct perception of the user. This avoids the risk of errors and/or absence of virtual picking up of the virtual object by the user.

Advantageously, the complementary gesture that is detected is sliding of the thumb against the index finger of the real hand.

The continuous gesture is thus simple and is not subject to a distinct perception of the user. This avoids the risk of errors and/or absence of virtual manipulation of the virtual object by the user.

Advantageously, the interaction method comprises:
lengthening the virtual arm attached to a virtual hand associated with a real hand moving toward a distant virtual object.

This thus facilitates a virtual interaction that is transparent to the user with both nearby virtual objects and distant virtual objects.

Advantageously, the interaction method comprises:
using a non-linear mapping between the movement of the real hand as captured in the real environment and the movement of the virtual hand in the immersive environment, the movement of the virtual hand depending on the captured movement of the real hand.

This thus makes the virtual interaction of the user with both nearby virtual objects and distant virtual objects intuitive, seamless and easy to use.

Advantageously, according to one implementation of the disclosure, the various steps of the method are implemented by software or a computer program, this software comprising software instructions intended to be executed by a data processor of a device forming part of an immersive reality device and being designed to control the execution of the various steps of this method.

An aspect of the disclosure therefore also targets a program comprising program code instructions for executing the steps of the interaction method according to the disclosure.

This program may use any programming language and be in the form of source code, object code or intermediate code between source code and object code, such as in a partially compiled form or in any other desirable form.

Another subject of the disclosure is an immersive reality device comprising:
a reproduction device for reproducing a virtual object;
a camera able to capture real hands of a user of the immersive reality device;
a gesture detector able to detect a continuous gesture of the real hand, the detection of the continuous gesture triggering gripping of the virtual object by the virtual hand when a virtual hand associated with a real hand of a user of the immersive reality device is in the proximity of a virtual object.

### BRIEF DESCRIPTION OF THE DRAWINGS

The features and advantages of one or more aspects of the disclosure will become more clearly apparent on reading the description, which is given by way of example, and the related figures, in which:

FIG. 1 shows a simplified diagram of a method for interacting with a virtual object according to an aspect of the disclosure;

FIG. 2 shows a simplified diagram of an immersive reality method according to an aspect of the disclosure,

FIG. 3 shows a simplified diagram of an immersive reality device according to an aspect of the disclosure,

FIG. 4a shows a simplified diagram of a first use case of an aspect of the disclosure when the user performs a continuous gesture with their real hand,

FIG. 4b shows a simplified diagram of a second use case of an aspect of the disclosure when the user performs a continuous gesture with their real hand,

FIG. 5a shows a simplified diagram of a use case of an aspect of the disclosure when the user moves their real hand during a continuous gesture of this real hand,

FIG. 5b shows a simplified diagram of a use case of an aspect of the disclosure when the user interrupts a continuous gesture with their real hand.

### DESCRIPTION OF THE EMBODIMENTS

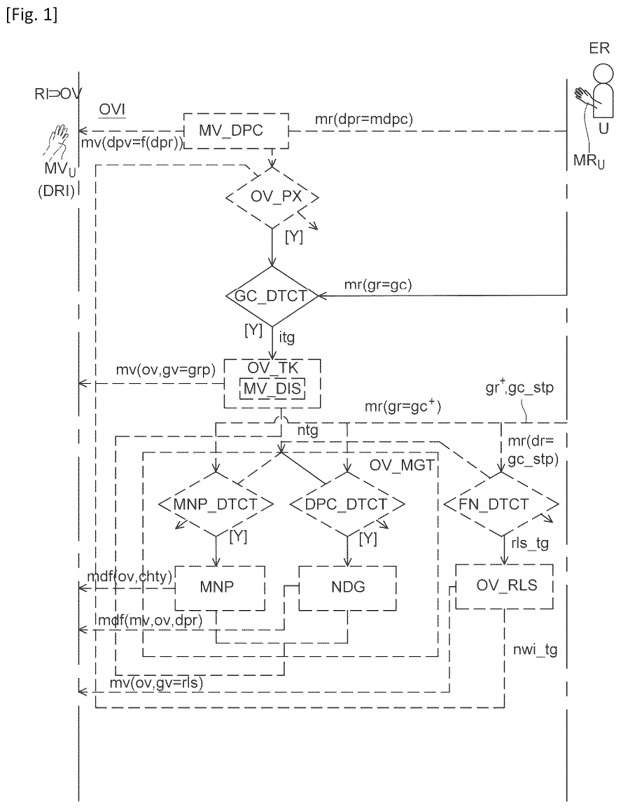

FIG. 1 illustrates a simplified diagram of a method for interacting with a virtual object according to an aspect of the disclosure.

The method for interacting with a virtual object OVI reproduced by an immersive reality device DRI comprises:
when a virtual hand MV_{U} associated with a real hand MR_{U} of a user U of the immersive reality device DRI is in the proximity of a virtual object OV: OV_PX=[Y], detecting a continuous gesture of the real hand GRP_DTCT, the detection of the continuous gesture GC_DTCT triggering itg gripping OV_TK of the virtual object OV by the virtual hand MV_{U}.

In particular, the continuous gesture is a gesture of contact of one part of the real hand with another part of the same real hand. The continuous gesture thus makes it possible to recreate the feeling of touch, which the user cannot feel by touching a virtual object.

In particular, the interaction method OVI comprises:
taking OV_TK the virtual object OV with the virtual hand MV_{U} as soon as a continuous gesture gc of the real hand MR_{U} is detected GC_DTCT.

In particular, the interaction method OVI comprises:
when the virtual hand MV_{U} is holding a virtual object OV, detecting FN_DTCT the interruption of the continuous gesture gc_stp of the real hand MR_{U}, the detection of interruption FN_DTCT triggering rls_tg the end of the gripping of the virtual object OV_RLS by the virtual hand MV_{U}.

In particular, the interaction method OVI comprises:
letting go OV_RLS of the virtual object OV held by the virtual hand MV_{U} as soon as interruption of the continuous gesture of the real hand is detected FN_DTCT.

In particular, the virtual object is gripped OV_TK by the virtual hand MV_{U} depending on the orientation of the palm of the virtual hand MV_{U} with respect to the virtual object OV when the continuous gesture is detected GC_DTCT.

In particular, the interaction method OVI comprises:
when the virtual hand MV_{U} is holding a virtual object OV, detecting a gesture of the real hand complementary to the detected continuous gesture MNP_DTCT, the detection of the complementary gesture MNP_DTCT triggering a rotation MNP of the virtual object OV in the virtual hand MV_{U}.

In particular, the continuous gesture gc that is detected is contact of the thumb and the index finger of the real hand.

In particular, the complementary gesture gc+ that is detected is sliding of the thumb against the index finger of the real hand.

In particular, the interaction method OVI comprises:
lengthening BV_NL the virtual arm BV_{U} attached to a virtual hand MV_{U} associated with a real hand MR_{U} moving toward a distant virtual object OV.

In particular, the interaction method comprises:
using a non-linear mapping MPNL between the movement dpr of the real hand mr as captured in the real environment ER and the movement of the virtual hand mv in the immersive environment RI, the movement dpv of the virtual hand mv depending on the captured movement of the real hand dpr.

A user U uses an immersive reality device DRI by way of which they visualize at least one virtual object OV in the immersive environment, also called immersive reality, RI: RI⊃OV.

The immersive reality device DRI allows the user U to interact with virtual objects OV in the immersive reality RI, in particular by way of the real hands MR_{U} of the user U. In order to facilitate the interaction of the user U with a virtual object OV in the immersive reality RI, virtual hands MV_{U} are generated in the immersive reality, associated with the real hands MR_{U} of the user U.

Thus, when the user U moves one of their real hands MR_{U} to move it toward a virtual object OV, the associated virtual hand MV_{U} moves in the same way in the immersive reality RI toward the virtual object OV.

In particular, the interaction method OVI receives captured data mr relating to the real hand MR_{U}. In the example above, in which a real hand MR_{U} moves toward a virtual object OV, the captured data relating to the real hand mr comprises movement data relating to the real hand dpr corresponding to the movement of the real hand mr: mr(dpc=mdpc).

In particular, the interaction method OVI comprises:
moving MV_DPC the virtual hand MV_{U} depending on the movement data in relation to the hand dpr.

The interaction method OVI thus provides the immersive reality with the movement command mv indicating the movement of the virtual hand dpv depending on the movement data in relation to the hand dpr: mv(dpv=f(dpr)).

If the virtual object OV is located in a plane of the immersive reality RI that is too far from the first plane in which the user U is located for said user to be able to reach it with one of their real hands MR_{U}, the interaction method OVI lengthens BV_NL (not illustrated) the virtual arm BV_{U} (not illustrated) attached to the virtual hand MV_{U} associated with the real hand MR_{U} with which the user is attempting to reach this virtual object OV.

Optionally, the lengthening of the virtual arm BV_NL uses a non-linear mapping MPNL (not illustrated) between the movement dpr of the real hand mr as captured in the real environment ER and the movement of the virtual hand mv in the immersive environment RI, the movement dpv of the virtual hand mv depending on the captured movement of the real hand dpr.

In particular, the interaction method OVI comprises proximity detection with a virtual object OV_PX. The proximity detection OV_PX is in particular implemented after each movement of the real hand MR_{U}. The proximity detection OV_PX is carried out on the basis of the position of the virtual hand mv_pos associated with the real hand and the position of the virtual object ov_pos.

The position of the virtual hand mv_pos depends on the position of the real hand mr_pos and, where applicable, on the lengthening of the virtual arm bv_nl. In particular, when the position of a hand is given as a polar coordinate centered on the user U, the angles of the polar coordinates of the virtual hand are equal to the polar coordinates of the real hand, and the distance of the virtual hand from the torso of the user U dv is equal to the distance of the real hand from the torso of the user U dr, or even to the elongated distance dnlv determined depending on the position of the nearest virtual object OV the polar coordinates angles of which are identical to those of the real hand.

Where applicable, the proximity detection OV_PX therefore takes into account the position of the virtual hand when the virtual arm is lengthened.

If a virtual hand is close to a virtual object OV_PX=[Y], then the interaction method OVI detects GC_DTCT whether the user U performs a continuous gesture gc with the associated real hand. In particular, the interaction method OVI uses the captured data relating to the real hand mr, which comprises data relating to the gestures performed by the real hand gr: mr(gr). The continuous gesture detection GC_DTCT thus consists in particular in evaluating whether the captured data relating to the real hand mr the data of which relating to the gestures performed by the real hand gr correspond to a continuous gesture: mr (gr=gc).

The continuous gesture gc is in particular a gesture distinct from a gesture close to a gesture of gripping the virtual object OV, in particular the gesture of taking the object by touching the fingers, which may be inappropriate depending on the diameter of the virtual object.

The continuous gesture gc is one of the following gestures:
the thumb touching the index finger,
the thumb touching the palm of the hand;
the hand being placed in a closed fist;
etc.

In particular, if a continuous gesture is detected GC_DTCT=[Y], then the interaction method OVI triggers an interaction itg of the user U with the virtual object OV, in particular by way of their real hand MR_{U}. The triggered interaction itg is that of picking up OV_TK the virtual object by way of the virtual hand MV_{U} of the user U.

The picking up OV_TK anchors the position of the virtual object OV to the position of the virtual hand MVU: ov_pos=f(mv_pos). Thus, when the user U moves their real hand MR_{U}, the associated virtual hand MV_{U} is moved accordingly, as is the object OV, since its position is anchored to that of the position of the virtual hand. Where applicable, when the virtual arm is lengthened during picking up (OV_TK), the evolution of the distance between the virtual object OV and the user U is proportional to the evolution of the distance between the real hand MR_{U} of the user U and their torso.

In particular, picking up the virtual object OV_TK comprises:
modifying the gesture of the virtual hand MV_DIS.

In particular, the modified gesture gv of the virtual hand MV_{U} is a gripping gesture grp around the virtual object OV.

In particular, the interaction method OVI provides data relating to the virtual hand mv performing the modified gesture gv of the virtual hand as a gripping gesture grp around the virtual object OV: mv(ov,gv=GRP), ov corresponding to the data relating to the virtual object OV, in the immersive reality RI.

As the user U continues to perform the continuous gesture gc with a real hand MR_{U}, multiple gestures gr of the real hand MRU may be captured and therefore detected.

In a first case, the gesture gr may be a gesture gc+ complementary to the continuous gesture, that is to say the user U continues the continuous gesture gc with the real hand MR_{U} and adds the complementary gesture gc+ thereto.

In particular, the interaction method OVI comprises
when the virtual hand MV_{U} is holding a virtual object OV, detecting a movement gesture of the real hand complementary to the detected continuous gesture DPC_DTCT, the detection of the complementary movement gesture DPC_DTCT triggering a movement NDG of the virtual object OV with the virtual hand MV_{U}.

In particular, the interaction method OVI comprises moving NDG the virtual object OV with the virtual hand MV_{U}. In particular, the movement NDG provides data relating to a modification of the virtual hand mv and of the virtual object ov depending on the detected movement of the real hand dpr: mdf(mv,ov,dpr).

In particular, the interaction method OVI comprises
when the virtual hand MV_{U} is holding a virtual object OV, detecting a fixed gesture of the real hand complementary to the detected continuous gesture MNP_DTCT, the detection of the fixed complementary gesture MNP_DTCT triggering a rotation MNP of the virtual object OV with the virtual hand MV_{U}.

In particular, the interaction method OVI comprises rotating MNP the virtual object OV with the virtual hand MV_{U}. In particular, the rotation MNP provides data relating to the modification of the virtual object ov depending on the detected gesture of the real hand chty: mdf(ov,chty).

In particular, the interaction method OVI comprises
when the virtual hand MV_{U} is holding a virtual object OV, detecting a gesture gc+ of the real hand complementary to the detected continuous gesture MNP_DTCT, DPC_DTCT, the detection of the complementary gesture MNP_DTCT triggering management OV_MGT of the virtual object OV in the virtual hand MV_{U}.

In particular, this complementary gesture gc+ makes it possible to manage OV_MGT the virtual object OV held by the virtual hand MV_{U}. Optionally, the management OV_MGT of the virtual object OV held by the virtual hand MV_{U} comprises detecting the complementary movement gesture DPC_DTCT and/or the movement NDG and/or detecting the fixed complementary gesture MNP_DTCT and/or the rotation MNP.

The complementary gesture gc+ is one of the following gestures:
a movement of one of the fingers relative to the others, such as:
+ the thumb moving along the index finger (for example, thumb−phalanx 0 or metacarpal=zero rotational speed, . . . , thumb−phalanx 3 or distal phalanx=maximum rotational speed; or
thumb−phalanx 0 or metacarpal=zero angle of rotation, thumb−phalanx 0 or proximal phalanx=90° angle of rotation, thumb−phalanx 2 or intermediate phalanx=180° angle of rotation, thumb−phalanx 0 or distal phalanx=270° angle of rotation; etc.);
+ the thumb moving against the palm of the hand so as to go from one finger to the next (for example, thumb−index finger=zero rotational speed, . . . , thumb−little finger=maximum rotational speed; or
thumb−index finger=zero angle of rotation, thumb−middle finger=90° angle of rotation, thumb−ring finger=180° angle of rotation, thumb−little finger=270° angle of rotation, etc.);
+ the thumb moving over the first so as to go from one finger to the next (for example, thumb−index finger=zero rotational speed, . . . , thumb−little finger=maximum rotational speed; or
thumb−index finger=zero angle of rotation, thumb−middle finger=90° angle of rotation, thumb−ring finger=180° angle of rotation, thumb−little finger=270° angle of rotation, etc.);
etc.

As soon as the real gesture gr has been implemented virtually MNP, NDG, then the interaction method OVI awaits ntg the next gesture.

In particular, the interaction method OVI comprises
when the virtual hand MV_{U} is holding a virtual object OV, detecting FN_DTCT the interruption of the continuous gesture gc_stp of the real hand MR_{U}, the detection of interruption FN_DTCT triggering rls_tg the end of the gripping of the virtual object OV_RLS by the virtual hand MV_{U}.

In particular, the interaction method OVI comprises:
letting go OV_RLS of the virtual object OV held by the virtual hand MV_{U} as soon as interruption of the continuous gesture of the real hand is detected FN_DTCT.

As soon as the virtual object OV has been released, then the interaction method OVI awaits nwi_tg the next continuous gesture to interact either again with this virtual object or with another virtual object in the immersive reality.

One particular embodiment of the interaction method OVI is a program comprising program code instructions for executing the steps of the interaction method OVI according to an aspect of the disclosure when said program is executed by a processor.

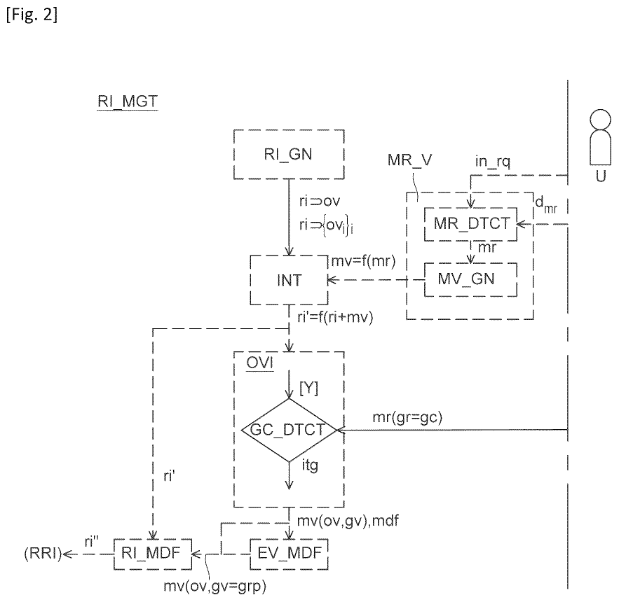

FIG. 2 illustrates a simplified diagram of an immersive reality method according to an aspect of the disclosure,

The immersive reality method RI_MGT, also called immersive reality management method, the immersive reality RI comprising at least one virtual object OV. The immersive reality method RI_MGT comprises:
when a virtual hand MV_{U} associated with a real hand MR_{U} of a user U of an immersive reality device DRI is in the proximity of a virtual object OV: OV_PX=[Y], detecting a continuous gesture of the real hand GRP_DTCT, the detection of the continuous gesture GC_DTCT triggering itg gripping OV_TK of the virtual object OV by the virtual hand MV_{U}; and
providing data relating to the immersive reality ri, ri′, ri″ to an immersive reality reproduction RRI.

In particular, the immersive reality method RI_MGT comprises:
generating RI_GN an immersive reality comprising at least one virtual object OV.

In particular, the immersive reality generation RI_GN provides data relating to the immersive reality ri, possibly comprising data relating to a virtual object ov or multiple virtual objects {ovᵢ}: ri⊃ov, ri⊃{ovᵢ}ᵢ.

In particular, the immersive reality method RI_MGT comprises:
detecting MR_DTCT one or even more real hands MR_{U} of a user U.

In particular, the detection of the real hands MR_DTCT retrieves captured data in relation to the real hands dmr and provides the data relating to the real hands mr on the basis of the captured data dmr.

In particular, when a user U accesses the immersive reality RI, they request in_rq, in particular by way of an input interface (not illustrated), the immersive reality method RI_MGT to integrate the immersive reality. This immersive reality integration request in_rq triggers the detection MR_DTCT of one or even more real hands MR_{U} of the user U.

In particular, the immersive reality method RI_MGT comprises:
generating MV_GN virtual hands MV_{U} associated with the user U.

In particular, the virtual hands MV_{U} are associated with the real hands MR_{U} of the user U. Where applicable, the data relating to the virtual hands as provided mv by the generation of virtual hands MV_GN depend on data relating to the real hands mr: mv=f(mr), for example provided by the detection of real hands MR_DTCT.

In particular, the immersive reality method RI_MGT comprises:
virtualizing MR_V the real hands of a user U.

The virtualization of the real hands MR_V provides data relating to virtual hands mv depending on data relating to the real hands mr: mv=f(mr).

In particular, the virtualization of the real hands MR_V comprises detecting real hands MR_DTCT and/or generating virtual hands MV_GN.

In particular, the immersive reality method RI_MGT comprises:
integrating virtual hands MV_{U} associated with the user U into the immersive reality RI.

The integration INT then provides a modified immersive reality RI′ into which the virtual hands MV_{U} have been integrated, in particular data relating to the modified immersive reality ri′ comprising data relating to the integrated virtual hands MV_{U} mv: ri′=f(ri+mv).

If a virtual hand is close to a virtual object OV_PX=[Y], then the interaction method OVI detects GC_DTCT whether the user U performs a continuous gesture gc with the associated real hand. In particular, the interaction method OVI uses the captured data relating to the real hand mr, which comprises data relating to the gestures performed by the real hand gr: mr(gr). The continuous gesture detection GC_DTCT thus consists in particular in evaluating whether the captured data relating to the real hand mr the data of which relating to the gestures performed by the real hand gr correspond to a continuous gesture: mr (gr=gc).

In particular, if a continuous gesture is detected GC_DTCT=[Y], then the interaction method OVI triggers an interaction itg of the user U with the virtual object OV, in particular by way of their real hand MR_{U}. The triggered interaction itg is that of picking up OV_TK the virtual object by way of the virtual hand MV_{U} of the user U.

In particular, the immersive reality method RI_MGT comprises:
interacting with a reproduced virtual object in an immersive reality OVI.

In particular, the interaction with a virtual object OVI being in particular the interaction method as illustrated by FIG. 1.

Optionally, the immersive reality method RI_MGT and/or the interaction method OVI comprises one or more of the following steps:
taking OV_TK the virtual object OV with the virtual hand MV_{U} as soon as a continuous gesture gc of the real hand MR_{U} is detected GC_DTCT. In particular, the picking up OV_TK provides data relating to the virtual hand mv performing the modified gesture gv of the virtual hand as a gripping gesture grp around the virtual object OV: mv(ov, gv), mv(ov,gv=grp), ov corresponding to the data relating to the virtual object OV, in the immersive reality RI;
manipulating MNP the virtual object OV with the virtual hand MV_{U}, in particular rotating the virtual object OV in the virtual hand MV_{U}. For example, the manipulation MNP provides data relating to the modification of the virtual object ov depending on the detected gesture of the real hand chty: mdf, mdf(ov,chty);
moving NDG the virtual object OV with the virtual hand MV_{U}. In particular, the movement NDG provides data relating to a modification of the virtual hand mv and of the virtual object ov depending on the detected movement of the real hand dpr: mdf, mdf(mv,ov,dpr).
letting go OV_RLS of the virtual object OV held by the virtual hand MV_{U} as soon as interruption of the continuous gesture of the real hand is detected FN_DTCT. In particular, the releasing OV_RLS provides data relating to the virtual hand mv performing the modified gesture gv of the virtual hand as a release gesture rls of releasing the virtual object OV: mv(ov, gv), mv(ov,gv=grp), ov corresponding to the data relating to the virtual object OV, in the immersive reality RI.

In particular, the immersive reality method RI_MGT comprises:
modifying one or more virtual elements EV_MDF in the immersive reality RI.

The virtual elements in the immersive reality comprise in particular one or more virtual objects OV and one or more virtual parts associated with the user U, for example virtual hands MV_{U}, virtual arms BV_{U}, etc.

In a first embodiment, virtual elements are modified EV_MDF directly in the immersive reality ri′ comprising the virtual hands.

In a second embodiment, the modification of virtual elements EV_MDF provides data relating to the modified virtual elements, in particular the data relating to the virtual hands mv and, where applicable, the data relating to the virtual object ov held by the user U.

In this second embodiment, the immersive reality method RI_MGT comprises:
modifying the immersive reality RI_MDF.

In particular, the immersive reality modification replaces the data relating to the modified virtual elements in the data relating to the immersive reality ri′ with the modified data relating to these virtual elements provided by the modification of virtual elements EV_MDF. The immersive reality modification provides a modified immersive reality ri″, taking into account in particular the picking up of the virtual object, to the immersive reality reproduction RRI.

One particular embodiment of the immersive reality method is a program comprising program code instructions for executing the steps of the immersive reality method according to an aspect of the disclosure when said program is executed by a processor.

An aspect of the disclosure also targets a medium. The information medium may be any entity or device capable of storing a program according to an aspect of the disclosure. For example, the medium may comprise a storage means, such as a ROM, for example a CD-ROM or a microelectronic circuit ROM, or else a magnetic recording means, for example a floppy disk or a hard disk.

On the other hand, the information medium may be a transmissible medium such as an electrical or optical signal that may be routed via an electrical or optical cable, by radio or by other means. The program according to an aspect of the disclosure may in particular be downloaded from a network, in particular the Internet.

As an alternative, the information medium may be an integrated circuit into which the program is incorporated, the circuit being designed to execute or to be used in the execution of the method in question.

In another implementation, an aspect of the disclosure is implemented by way of software components and/or hardware components. With this in mind, the term module may correspond both to a software component and to a hardware component. A software component corresponds to one or more computer programs, one or more subroutines of a program or, more generally, to any element of a program or of software that is able to implement a function or a set of functions according to the above description. A hardware component corresponds to any element of a hardware assembly that is able to implement a function or a set of functions.

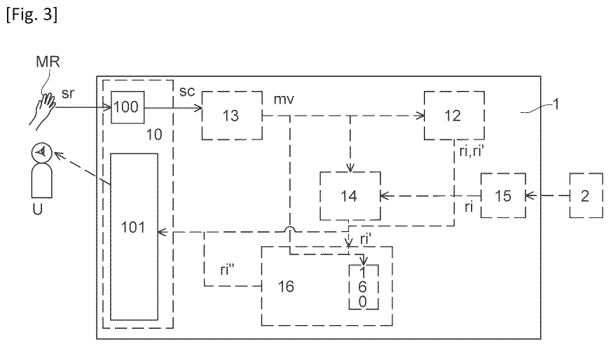

FIG. 3 illustrates a simplified diagram of an immersive reality device according to an aspect of the disclosure.

The immersive reality device 1 comprises:
a reproduction device 101 for reproducing a virtual object;
a camera 100 able to capture real hands of a user of the immersive reality device;
a gesture detector 160 able to detect a continuous gesture gc of the real hand, the continuous gesture detector being able to trigger gripping of the virtual object by the virtual hand when a virtual hand associated with a real hand of a user of the immersive reality device is in the proximity of a virtual object.

In particular, a user U uses an immersive reality RI reproduced by the reproduction device 101.

In particular, the user U interacts with this immersive reality RI, for example with the immersive reality device 1, by way of their real hands MR_{U}.

In particular, at least one camera 100 is able to capture data relating to the user sr and provides the captured data sc. These captured data sc comprise in particular data relating to the real hands mr.

In particular, the immersive reality device 1 comprises a user interface 10 comprising:
the reproduction device 101 for reproducing a virtual object; and/or
the camera 100 able to capture real hands of a user of the immersive reality device.

In particular, the immersive reality device 1 comprises a virtual-hand generator 13 able to provide data relating to virtual hands mv associated with the user U, in particular their real hands.

In particular, an immersive reality generator 2, 12 is able to provide data relating to an immersive reality ri, ri′ comprising data relating to one or more virtual objects ov.

In one particular embodiment, the immersive reality device 1 comprises the immersive reality generator 12. In particular, the immersive reality generator 12 is able to receive the data relating to the virtual hands mv and integrate them with the immersive reality data ri so as to provide immersive reality data ri′ additionally comprising the data relating to the virtual hands mv.

In one alternative embodiment, the immersive reality device 1 is able to be connected to an immersive reality generator 2 distinct from the immersive reality device 1. The immersive reality device 1 optionally comprises a communication interface 15 able to connect the immersive reality device 1 to the immersive reality generator 2, in particular via a communication network 3 (not illustrated). The communication interface 15 comprises in particular a communication cable connector, a receiver via the communication network 3, etc. In this case, the immersive reality generator 2 is able to provide data relating to an immersive reality ri, and the communication interface 15 is able to relay, in the immersive reality device 1, the received data relating to an immersive reality ri.

In particular, the immersive reality device 1 comprises a virtual-hand integrator 14 able to integrate the data relating to the virtual hands into the immersive reality data ri provided by the immersive reality generator 12, 2.

In particular, the immersive reality device 1 comprises:
an interaction device 16 able to implement an interaction with a virtual object reproduced in an immersive reality.

In particular, the interaction device 16 for interacting with a virtual object comprises a memory storing the interaction method OVI as illustrated by FIG. 1, and a processor implementing the instructions of the interaction method.

Optionally, the immersive reality device 1 and/or the interaction device 16 comprises one or more of the following devices (not illustrated):
a gripping device (or handling device) able to take a virtual object OV with a virtual hand MV_{U} as soon as a continuous gesture gc of the real hand MR_{U} is detected. In particular, the gripping device is able to provide data relating to the virtual hand mv performing the modified gesture gv of the virtual hand as a gripping gesture grp around the virtual object OV: mv(ov, gv), mv(ov,gv=grp), ov corresponding to the data relating to the virtual object OV, in the immersive reality RI;
a manipulation device able to manipulate a virtual object OV with a virtual hand MV_{U}, in particular able to rotate the virtual object OV in the virtual hand MV_{U}. For example, the manipulation device is able to provide data relating to the modification of the virtual object ov depending on the detected gesture of the real hand chty: mdf(ov,chty).
a movement device able to move a virtual object OV with a virtual hand MV_{U}. In particular, the movement device is able to provide data relating to a modification of the virtual hand mv and of the virtual object ov depending on the detected movement of the real hand dpr: mdf, mdf(mv,ov,dpr).
a releasing device able to release the virtual object OV held by the virtual hand MV_{U} as soon as interruption of the continuous gesture of the real hand is detected FN_DTCT. In particular, the releasing device is able to provide data relating to the virtual hand mv performing the modified gesture gv of the virtual hand as a release gesture rls of releasing the virtual object OV: mv(ov, gv), mv(ov,gv=grp), ov corresponding to the data relating to the virtual object OV, in the immersive reality RI.

In particular, the immersive reality device 1 and/or the interaction device 16 comprises:
a virtual-element modifier able to modify one or more virtual elements in the immersive reality.

The virtual elements in the immersive reality comprise in particular one or more virtual objects OV and one or more virtual parts associated with the user U, for example virtual hands MV_{U}, virtual arms BV_{U}, etc.

In a first embodiment, the virtual-element modifier is able to perform the modification directly in the immersive reality ri′ comprising the virtual hands.

In a second embodiment, the virtual-element modifier is able to provide data relating to the modified virtual elements, in particular the data relating to the virtual hands mv and, where applicable, the data relating to the virtual object ov held by the user U.

In this second embodiment, the immersive reality device 1 and/or the interaction device 16 comprises:
an immersive reality modifier.

In particular, the immersive reality modifier is able to replace the data relating to the modified virtual elements in the data relating to the immersive reality ri′ with the modified data relating to these virtual elements provided by the virtual-element modifier. The immersive reality modifier is able to provide a modified immersive reality ri″, taking into account in particular the picking up of the virtual object, to the immersive reality reproduction device 101.

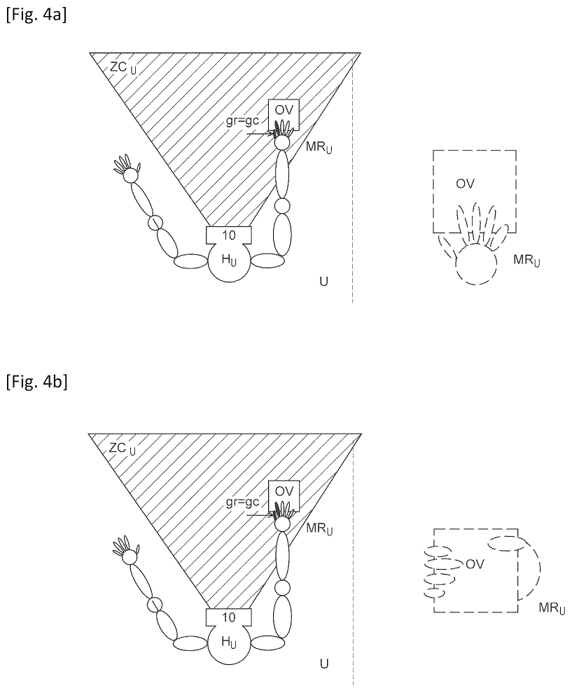

FIGS. 4a and 4b show two virtual gripping modes triggered by an aspect of the disclosure when the user performs a continuous gesture with their real hand.

The user U is shown from above. It is possible to see their head Hu, their shoulders, their arms and their hands. They are equipped with an immersive reality device 1 comprising a human-machine interface 10, in particular in the form of an immersive reality headset (or HDM for head-mounted display).

The human-machine interface 10 has in particular a hand-tracking area, illustrated by the hatched cone ZC_{U}. This hand-tracking area depends on the at least one camera with which the immersive reality device 1 is equipped.

In these two cases, the user U performs a gesture gr with their real hand MR_{U}, in this case a continuous gesture gc while their real hand MR_{U} is in the proximity of or even on a virtual object OV. The continuous gesture gc illustrated by FIGS. 4a and 4b is the thumb touching the index finger, as shown in the left-hand part of these figures.

FIG. 4a illustrates a simplified diagram of a first use case of an aspect of the disclosure when the user performs a continuous gesture with their real hand.

In this first use case, the virtual hand MV_{U} keeps the same posture as the associated real hand MR_{U}, in this case flat above the virtual object VR. The continuous gesture go then triggers association of the virtual object OV with the virtual hand MV_{U} as though the virtual object OV were stuck to the virtual hand MV_{U}, and consequently to the associated real hand MR_{U}. Any movement of the real hand MRU thus triggers not only the same movement of the virtual hand, but also causes the same movement of the virtual object as though the real hand MR_{U} were pushing the virtual object OV simply by being pressed against it.

FIG. 4b illustrates a simplified diagram of a second use case of an aspect of the disclosure when the user performs a continuous gesture with their real hand.

In this second use case, the virtual hand MV_{U} adopts a gripping posture adapted to the virtual object OV, regardless of the posture of the associated real hand MR_{U}, for as long as the continuous gesture gc is maintained. Any movement of the real hand MRU thus triggers not only the same movement of the virtual hand, but also causes the same movement of the virtual object as though the real hand MR_{U} were pushing the virtual object OV simply by being pressed against it.

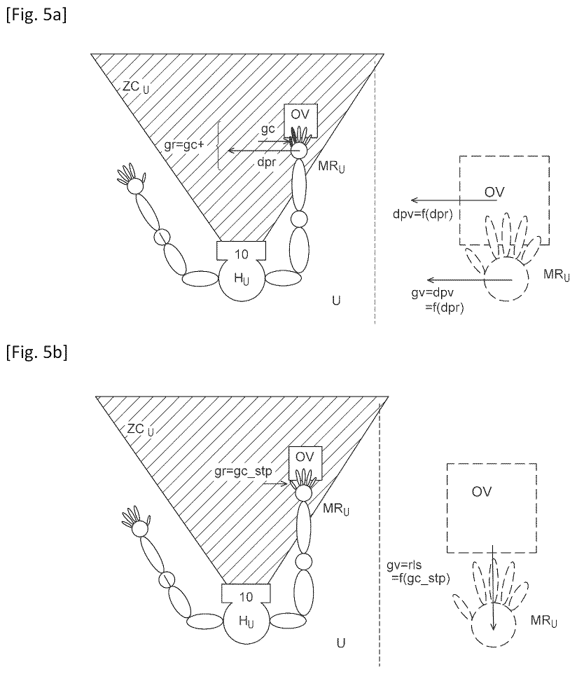

FIGS. 5a and 5b show two use cases following virtual gripping of a virtual object by way of a continuous gesture of a real hand of the user according to an aspect of the disclosure.

The user U is shown from above. It is possible to see their head Hu, their shoulders, their arms and their hands. They are equipped with an immersive reality device 1 comprising a human-machine interface 10, in particular in the form of an immersive reality headset (or HDM for head-mounted display).

The human-machine interface 10 has in particular a hand-tracking area, illustrated by the hatched cone ZC_{U}. This hand-tracking area depends on the at least one camera with which the immersive reality device 1 is equipped.

FIG. 5a illustrates a simplified diagram of a use case of an aspect of the disclosure when the user moves their real hand during a continuous gesture of this real hand,

The user U performs a gesture gr with their real hand MR_{U}, in this case a gesture gc+ complementary to the continuous gesture gc, while their real hand MR_{U} is in the proximity of or even on a virtual object OV. The continuous gesture gc illustrated by FIG. 5a is the thumb touching the index finger, as shown in the left-hand part of these figures. The complementary gesture gc+ that is illustrated is a movement of the real hand dpr, in this case to the left.

The virtual hand MV_{U} keeps the same posture as the associated real hand MR_{U}, in this case flat above the virtual object VR, as illustrated previously by FIG. 4a. With the continuous gesture gc having then triggered association of the virtual object OV with the virtual hand MV_{U} as though the virtual object OV were stuck to the virtual hand MV_{U}, and consequently to the associated real hand MR_{U}, then the movement of the real hand dpr to the left triggers not only the movement of the virtual hand gv=dpv=f(dpr) to the left, but also causes the same movement of the virtual object dpv=f(dpr) as though the real hand MR_{U} were pushing the virtual object OV simply by being pressed against it.

FIG. 5b illustrates a simplified diagram of a use case of an aspect of the disclosure when the user interrupts a continuous gesture with their real hand.

The user U performs a gesture gr with their real hand MR_{U}, in this case interruption of the continuous gesture gc_stp.

The virtual hand MV_{U} keeps the same posture as the associated real hand MR_{U}, in this case flat above the virtual object VR. The gesture of interrupting the continuous gesture gc_stp then triggers dissociation of the virtual object OV from the virtual hand MV_{U} as though the virtual object OV were unstuck from the virtual hand MV_{U}, and consequently from the associated real hand MR_{U}. A subsequent movement of the real hand MRU thus triggers only the same movement of the virtual hand. The virtual object OV will then remain in the position that it was in when the real hand MR_{U} released it gc_stp.

An aspect of the disclosure thus proposes a simple interaction technique that consists in particular in the thumb touching the index finger next to it. This gesture is detected based in particular on generation of a virtual hand associated with a real hand of the user or virtualization of a real hand of the user, in particular by reconstructing the hand of the user by way of the immersive or augmented reality headset that they are wearing or using a depth camera that reconstructs the geometry of the hand. The geometry of the virtual hand of the user makes it possible to detect the continuous gesture, in particular the thumb touching the index finger.

This interaction technique according to an aspect of the disclosure has multiple advantages:
it avoids having to carry an input peripheral, in particular a manual interface such as a ring, and therefore simplifies use thereof in a real environment, in particular in the context of a work environment such as the activity of a network engineer;
it is simple to implement;
it allows the user to associate touch with the interaction with the virtual object. The user touches their own hand to have this feeling of touch, which the interaction with a virtual object cannot give them: The feeling of touching the virtual object is thus brought about by the touching of their own hand necessary for interacting with the virtual object. This therefore makes it possible to increase the number of sensorimotor modalities involved in the interaction;
it makes it possible to let go of the virtual object easily by removing this feeling of touch, in particular by moving their thumb away from the index finger;
it makes it possible to be able to rotate the object in their hand simply by modifying the touch, in particular by sliding the thumb along the index finger.

1. An interaction method for interacting with a virtual object reproduced by an immersive reality device, the method being performed by the immersive reality device and comprising:
In response to a virtual hand associated with a real hand of a user of the immersive reality device being in proximity of a virtual object, detecting a continuous gesture of the real hand, the detection of the continuous gesture triggering gripping of the virtual object by the virtual hand.

2. The interaction method according to claim 1, wherein the interaction method comprises:
taking the virtual object with the virtual hand as soon as a continuous gesture of the real hand is detected.

3. The interaction method according to claim 1, wherein the interaction method comprises:
when the virtual hand is holding a virtual object, detecting an interruption of the continuous gesture of the real hand, the detection of the interruption of the continuous gesture triggering an end of the gripping of the virtual object by the virtual hand.

4. The interaction method according to claim 1, wherein the interaction method comprises:
letting go of the virtual object held by the virtual hand as soon as interruption of the continuous gesture of the real hand is detected.

5. The interaction method according to claim 1, wherein the virtual object is gripped by the virtual hand depending on an orientation of the palm of the virtual hand with respect to the virtual object when the continuous gesture is detected.

6. The interaction method according to claim 1, wherein the interaction method comprises:
when the virtual hand is holding a virtual object, detecting a gesture of the real hand complementary to the detected continuous gesture, detecting a complementary gesture triggering a rotation of the virtual object in the virtual hand.

7. The interaction method according to claim 1, wherein the detected continuous gesture is contact of the thumb and the index finger of the real hand.

8. The interaction method according to claim 7, wherein the interaction method comprises:
when the virtual hand is holding a virtual object, detecting a gesture of the real hand complementary to the detected continuous gesture, detecting a complementary gesture triggering a rotation of the virtual object in the virtual hand, wherein the complementary gesture that is detected is sliding of the thumb against the index finger of the real hand.

9. The interaction method according to claim 1, wherein the interaction method comprises:
lengthening a virtual arm attached to a virtual hand associated with a real hand moving toward a distant virtual object.

10. The interaction method according to claim 9, wherein the interaction method comprises:
using a non-linear mapping between the movement of the real hand as captured in a real environment and the movement of the virtual hand in an immersive environment, the movement of the virtual hand depending on the captured movement of the real hand.

11. A non-transitory computer readable medium comprising a program stored thereon and comprising program code instructions for executing the interaction method according to claim 1 when said program is executed by processor of the immersive reality device.

12. An immersive reality device comprising:
a reproduction device for reproducing a virtual object;
a camera able to capture real hands of a user of the immersive reality device; and
a gesture detector able to detect a continuous gesture of the real hand, the detection of the continuous gesture triggering gripping of the virtual object by the virtual hand when a virtual hand associated with a real hand of a user of the immersive reality device is in proximity of the virtual object.
